(19) United States
(12) Patent Application Publication
(10) Pub. No.: US 2005/0011171 A1
(43) Pub. Date: Jan. 20, 2005

(54) Air cleaner

(75) Inventors: Ju Youn Lee, Seoul (KR); Jeong Yong Kim, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/880,490

(22) Filed: Jul. 1, 2004

(30) Foreign Application Priority Data
Jul. 8, 2003 (KR) P2003-46055

(51) Int. Cl. B01D 46/00

(52) U.S. Cl. 55/471

(57) ABSTRACT

Disclosed is an air cleaner for controlling a temperature of cleaned air, including a housing for receiving various parts, an inlet provided in the housing for drawing in air to be cleaned, a filtering member for filtering the drawn air so as to remove various contaminants, a fan for drawing in the filtered air and blowing out, an outlet provided in the housing for discharging the filtered air, and a controller for controlling a temperature of filtered air according to room temperature.

### CROSS-REFERENCE TO RELATED APPLICATIONS

This application claims the benefit of Korean Application No. P2004-46055, filed on Jul. 8, 2003, which is hereby incorporated by reference as if fully set forth herein.

### BACKGROUND OF THE INVENTION

1. Field of the Invention

The present invention relates to an air cleaner, and more particularly, to an apparatus for controlling a temperature of air purified by the air cleaner.

2. Discussion of the Related Art

An air cleaner is an apparatus for changing polluted air into clean air. In general, the air cleaner draws in a polluted interior air and filters pollutants such as dust and germs, and stink therein. The filtered air is then discharged out of the air cleaner. By repeating the process, the polluted interior air is cleaned.

However, in the air cleaner, temperature of the drawn air is same as that of the discharged air, resulting in giving a bad feeling to a user.

In other words, when the air cleaner is used at a relatively low room temperature (for instance, in the winter), the air cleaner discharges air at a low temperature as it is. Accordingly, the user can feel cold owing to the discharged air at lower temperature. On the other hand, when the air cleaner is used at a relatively high room temperature (for instance, in the winter), the air cleaner discharges the discharged air at the high temperature. Therefore, the user can feel hot owing to the discharged hot air.

### SUMMARY OF THE INVENTION

Accordingly, the present invention is directed to an air cleaner that substantially obviates one or more problems due to limitations and disadvantages of the related art.

An object of the present invention is to provide an air cleaner for controlling a temperature of cleaned air according to a room temperature.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an air cleaner includes a housing for receiving various parts; an inlet provided in the housing for drawing in air to be cleaned; a filtering member for filtering the drawn air so as to remove various contaminants; a fan for drawing in the filtered air and blowing out; an outlet provided in the housing for discharging the filtered air; and a controller for controlling a temperature of filtered air according to a room temperature.

The controller cools the filtered air when the room air temperature is high, or heats the filtered air when the room air temperature is low. In a practical manner, the controller includes a regenerator for accumulating heat absorbed from the filtered air, or accumulating heat to be released to the filtered air beforehand.

The regenerator includes a container having a predetermined inner space therein, and a regenerating material stored in the container. The regenerating material includes a material having high conductivity, and in a practical matter, aqueous solution such as water or salt water having high conductivity.

The controller, desirably, further includes a heat exchanging member heat-coupled with the regenerating material for additionally exchanging heat with the filtered air. The heat exchanging member is at least partially in contact with the regenerator, desirably partially inserted into the regenerator. The heat exchanging member includes at least one more pipe in a practical manner, and further includes at least one fin. Furthermore, the heat exchanging member further includes a regenerating material stored therein.

The controller is cooled beforehand for absorbing heat from the filtered air, or heated beforehand for releasing heat to the filtered air. It is desirable that the controller is provided to be totally detachable from the housing. In more detail, the regenerator is detachably provided at the housing, and the heat exchanging member is detachably provided at the regenerator. Lastly, it is desirable that the controller is provided adjacent to the outlet so as to effectively control the temperature of the filtered air.

The temperature of the cleaned air is properly controlled according to the room temperature so as to provide pleasant freshness to the user.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view of an air cleaner in accordance with the present invention;

FIG. 2 illustrates an exploded view of an air cleaner in accordance with the present invention;

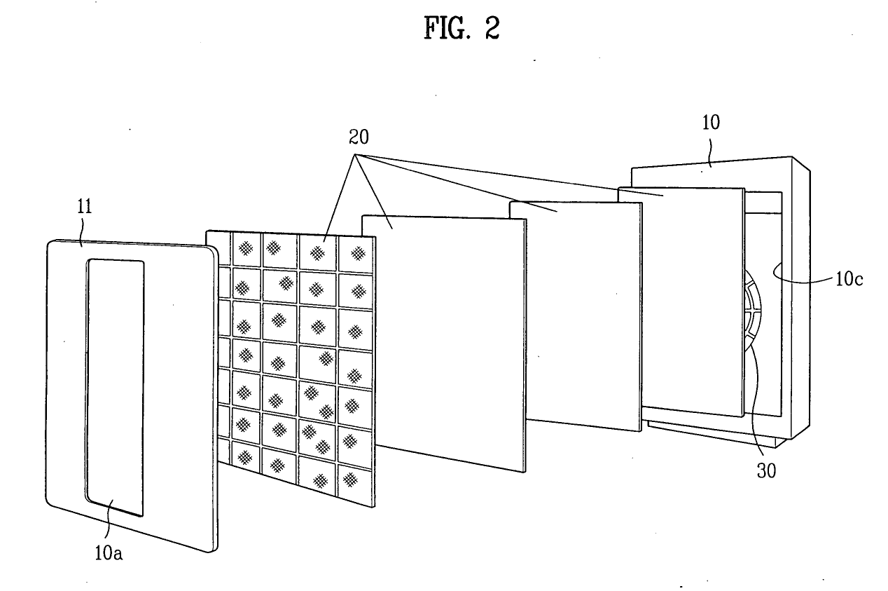

FIG. 3 illustrates a cutaway view showing a structure of an air cleaner in accordance with the present invention, schematically.

FIG. 4 illustrates a floor plan showing an apparatus for controlling a temperature in accordance with the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

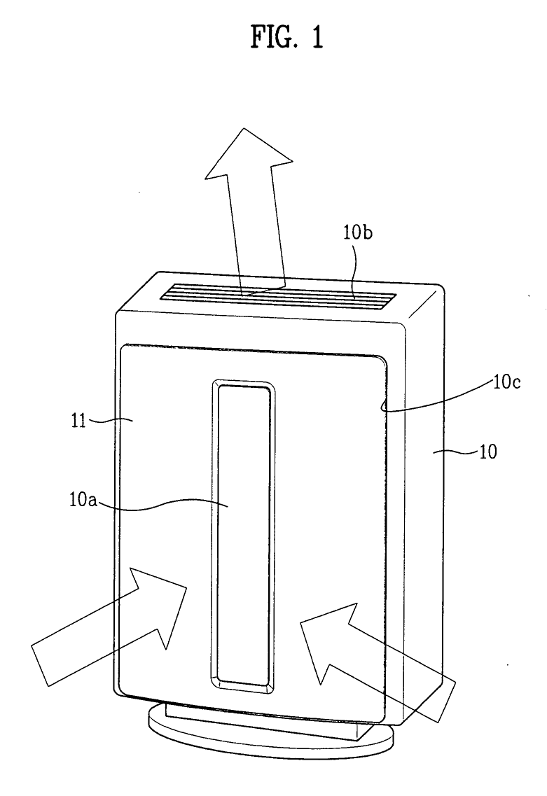

First, FIG. 1 illustrates a perspective view of an air cleaner in accordance with the present invention. As illustrated in FIG. 1, the air cleaner in accordance with the present invention includes a housing 10, an inlet and outlet 10a and 10b, respectively, formed in the housing 10, a filtering member 20 provided in the housing 10, a fan 30, a controller 40.

The housing 10 is configured to include various parts such as the filtering member 20, the fan 30, and the controller 40. The housing 10 includes an opening 10c in a predetermined size and a panel 11 for covering the opening 10c thereof. The panel 11 is detachable for easy maintenance of the air cleaner. In other words, when the panel 11 is separated, various parts of the air cleaner are exposed so as to enable a user to reach the parts through the opening 10c for fixing and exchanging parts.

As abovementioned, the housing 10 includes the inlet and outlet 10a and 10b. The inlet and outlet 10a and 10b draws in room air to be purified, and discharges the room air. The inlet 10a is provided in a large size on a front side of the housing 10, particularly at the panel 11 for drawing larger amount of air at a time. The outlet 10b is provided at an upper part of the housing. Therefore, the purified air is discharged to the upper part of the room so as to spread widely.

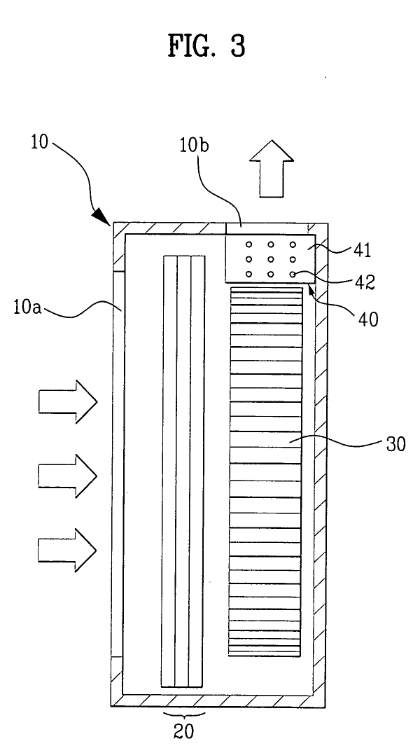

The filtering member 20 performs a role of filtering various kinds of contaminants contained in air drawn through the inlet 10a. Desirably, the filtering member 20 is configured to remove odors in the drawn air. For removing odors, the filtering member 20 includes an assembly having a plurality of filters such as a pre-filter, an odor-removing filter, and dust collecting filter. As illustrated in FIG. 3, the filtering member 20 is provided to face the inlet 10a for filtering the drawn air right away. Accordingly, the drawn air is effectively filtered.

The fan 30 draws in the filtered air and blows out to discharge the air to an outside of the air cleaner. In more detail, the fan 30 is provide at a rear side of the filtering member 3 as illustrated in FIG. 3. A cross fan is used for drawing in air in an axis direction and blowing air out in a radius direction.

As illustrated in FIG. 3, the controller 40 is configured basically to control an air temperature of the filtered air according to a room temperature. In other words, the controller 40 cools the filtered air when the room temperature is relatively high, and heats when the room temperature is relatively low. Although various mechanisms can be used as the controller 40, a regenerator 41 is desirable owing to a simple structure thereof.

The regenerator 41 basically accumulates heat absorbed from the filtered air, or heat released to the filtered air. In other words, when the room temperature is high, the regenerator 41 absorbs heat from the filtered air to cool the filtered air and accumulates the absorbed heat therein.

When the room temperature is low, the regenerator 41 accumulates a predetermined amount of heat beforehand from other heat sources for heating the filtered air, and releases heat to the filtered air.

The regenerator 41 includes a container having a predetermined inner space and a regenerating material stored in the container. In this case, the regenerator includes a high specific heat. As abovementioned, the specific heat is an amount of heat required to raise one degree of temperature. Therefore, the material having the high specific heat has a high heat capacity, i.e., regenerating heat amount, thus is suitable for the regenerating material of the present invention. In a practical manner, aqueous solution such as water or salt having the high specific heat is used in the present invention.

The regenerator 41 further includes a heat exchanging member 42 for additionally exchanging heat with the filtered air. The heat exchanging member 42 is heat coupled with the regenerator 41 for performing same function as that of the regenerator 41.

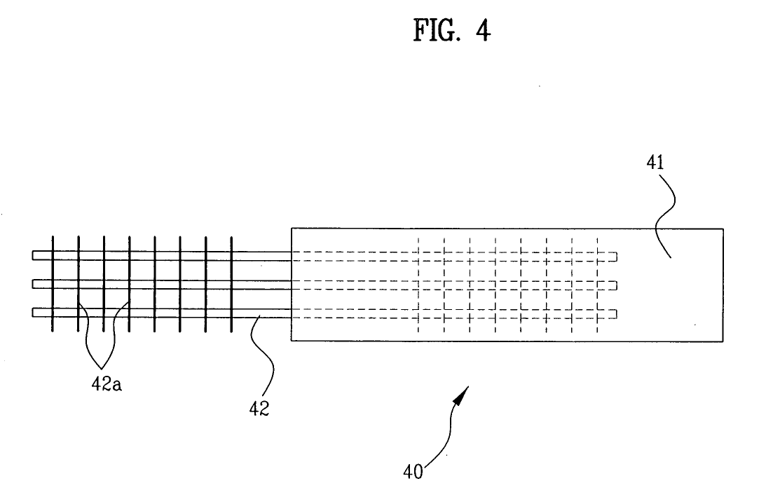

In other words, the heat exchanging member 42 is supplied with heat from the regenerator 41 so as to heat the filtered air through heat exchanging (i.e., heat release). The heat exchanging member 42 supplies the absorbed heat to the regenerator 41 to be stored therein by cooling the filtered air through heat exchange, i.e., heat release. Therefore, the heat exchanging member 42 is made of a material with high heat conductivity, being at least partially in contact with the regenerator 41 so as to be heat-coupled. As illustrated in FIG. 4, since the heat exchanging member 42 can be stably provided, it is desirable that the heat exchanging member 542 is partially inserted into an inside of the regenerator 41. The heat exchanging member 42, in a practical manner, includes a pipe with high heat conductivity as illustrated in the drawing. When the pipe is used as the heat exchanging member 42, a plurality of pipe is separately arranged at predetermined intervals in a limited space in the air cleaner. Therefore, it is very advantageous to use the pipe for increasing heat exchange area. The heat exchanging member 42 further comprises a fin 42a for increasing efficiency of heat exchange with the air being in contact with. As illustrated in the drawing, the fin 42a is provided to cross the heat exchanging member 42 that is the pipe. In this case, the fin 42a can be additionally provided in the regenerator 42 together with the heat exchanging member 42 to be in contact with the regenerator 42 for increasing the efficiency of heat exchange with the regenerator 41. Furthermore, the heat exchanging member 42 is provided to store the regenerating material in a same way of the regenerator 41.

Meanwhile, as aforementioned, the controller 40 needs to release enough heat beforehand for absorbing heat from the filtered air and needs to absorb and accumulate enough heat beforehand for releasing enough heat to the filtered air. Accordingly, the controller 40 needs to be cooled or heated ahead. In the practical manner, the controller 40 can be cooled at a refrigerator/freezer and heated in a microwave. The controller 40, particularly the regenerator 41 needs to be separated from the air cleaner to be cooled or heated. Accordingly, the regenerator 41 is detachably provided at the regenerator 41. The regenerator 41 needs to be detachable from the heat exchanging member 42 so as to heat or cool out of the air cleaner. Therefore, in the same manner, the heat exchanging member 42 is detachably provided. When the heat exchanging member 42 includes the regenerating material for performing the same function as the regenerator 41, the heat exchanging member 42 also needs to be detachably provided with a same reason as the heat exchanging member 42. Lastly, the controller 40 can be provided at anywhere on the flowing passage of the filtered air. However, when the air flowing speed is secured, the filtered air is more effectively cooled or heated. Therefore, as illustrated in FIG. 3, it is desirable that the controller 40 is provided adjacent to the outlet 10b so as to exchange heat with the air blown from the fan 30, particularly between the outlet 10b and the fan 30.

In accordance with the present invention, an operation of the air cleaner will be described as follows. When the air cleaner started operation, the room air polluted by a sucking power of the fan 30 is drawn into the housing 10 through the inlet 10a. While the room air is passed through the filtering member 20 various contaminants and odors are filtered by the filtering member 20, and the filtered air is blown to the outlet 10b by the fan 30.

In this case, when the room temperature is relatively higher than a proper temperature (particularly in the summer), the controller 40, specifically the regenerator 41 is separated beforehand from the air cleaner, cooled enough to release heat, and then provided back to the air cleaner.

On the other hand, when the room temperature is relatively higher than a proper temperature (particularly in the winter), the controller 40 is separated beforehand from the air cleaner, heated enough to absorb and accumulate heat, and provided back to the air cleaner.

Therefore, when the blown air passes through the controller provided adjacent to the outlet 10b, the air temperature is controlled according to the room temperature. In other words, when the room temperature is high, the controller 40 absorbs heat from the air and accumulates the heat therein so as to cool the air. When the room temperature is low, the controller 40 releases the accumulated heat into the air so as to heat the air. Therefore, the temperature of the filtered air is appropriately increased or decreased according to the room temperature. Likewise, when the controller 40 absorbs heat as much as its thermal capacity or releases all the accumulated heat, the controller 40 is cooled or heated again for absorbing heat from the filtered air or releasing heat to the filtered air. Then, the air of which temperature is controlled is discharged through the outlet 10b.

Repeating a series of abovementioned process, the polluted room air is gradually changed into fresh air. At a same time, the user does not feel cold or hot during the operation of the air cleaner owing to the cooled or heated air being continuously supplied.

An effect of the air cleaner in accordance with the present invention is summarized as follows. The present invention controls the temperature of the filtered air to be higher or lower than the room air according to the room temperature. Accordingly, the user feels warm when the room temperature is low, and the user feels cool when the room temperature is high. Therefore, the air cleaner in accordance with the present invention provides the user not only fresh air but also pleasant freshness.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An air cleaner, comprising:
a housing for receiving various parts;
an inlet provided in the housing for drawing in air to be cleaned;
a filtering member for filtering the drawn air so as to remove various contaminants;
a fan for drawing in the filtered air and blowing out;
an outlet provided in the housing for discharging the filtered air; and
a controller for controlling a temperature of filtered air according to a room temperature.

2. The air cleaner as claimed in claim 1, wherein the controller cools the filtered air when the room temperature is high and heats the filtered air when the room temperature is low.

3. The air cleaner as claimed in claim 1, wherein the controller comprises a regenerator for accumulating heat absorbed from the filtered air or accumulating heat to be released to the filtered air beforehand.

4. The air cleaner as claimed in claim 3, wherein the regenerator comprises:
a container having a predetermined inner space therein; and
a regenerating material stored in the container.

5. The air cleaner as claimed in claim 3, wherein the regenerating material includes a material having high conductivity.

6. The air cleaner as claimed in claim 4, wherein the regenerating material includes an aqueous solution such as water or salt water having high conductivity.

7. The air cleaner as claimed in claim 3, wherein the controller further comprises a heat exchanging member heat-coupled with the regenerating material for additionally exchanging heat with the filtered air.

8. The air cleaner as claimed in claim 7, wherein the heat exchanging member is at least partially in contact with the regenerator.

9. The air cleaner as claimed in claim 7, wherein the heat exchanging member is partially inserted into the regenerator.

10. The air cleaner as claimed in claim 7, wherein the heat exchanging member comprises at least one pipe.

11. The air cleaner as claimed in claim 7, wherein the heat exchanging member further comprises at least one fin.

12. The air cleaner as claimed in claim 7, wherein the heat exchanging member further comprises a regenerative material stored therein.

13. The air cleaner as claimed in claim 1, wherein the controller is cooled beforehand for absorbing heat from the filtered air, or heated beforehand for releasing heat to the filtered air.

14. The air cleaner as claimed in claim 13, wherein the controller is cooled in a refrigerator/freezer, or is heated in a microwave.

15. The air cleaner as claimed in claim 1, wherein the controller is detachably provided.

16. The air cleaner as claimed in claim 3, wherein the regenerator is detachably provided at the housing.

17. The air cleaner as claimed in claim 7, wherein the heat exchanging member is detachably provided at the regenerator.

18. The air cleaner as claimed in claim 1, wherein the controller is provided adjacent to the outlet.

19. The air cleaner as claimed in claim 1, wherein the fan includes a cross fan for drawing in air in an axis direction and blowing out in a radius direction.
